(19) United States
(12) Patent Application Publication
(10) Pub. No.: US 2010/0079080 A1
(43) Pub. Date: Apr. 1, 2010

(54) Gamma Generator System and Method Adaptable for Backlight Control

(76) Inventors: Shing-Chia Chen, Tainan (TW); Lin-Kai Bu, Tainan (TW)

Correspondence Address: STOUT, UXA, BUYAN & MULLINS LLP, 4 VENTURE, SUITE 300, IRVINE, CA, 92618, US

(21) Appl. No.: 12/242,689

(22) Filed: Sep. 30, 2008

(51) Int. Cl. H05B 41/36; G09G 3/36

(52) U.S. Cl. 315/291; 345/102

(57) ABSTRACT

A gamma reference voltage generating system and method adaptable for backlight control is disclosed. A gamma reference voltage generator adaptively generates an analog gamma reference voltage under the control of a digital control signal. The digital control signal is specifically arranged to accordingly level-up an upper limit of a gamma curve, thereby improving brightness loss.

### BACKGROUND OF THE INVENTION

1. Field of the Invention

The present invention generally relates to backlight control, and more particularly to a gamma reference voltage generating system and method adaptable for the backlight control.

2. Description of the Prior Art

Backlighting is used to illuminate a flat panel display, such as liquid crystal display (LCD), from the back or side of the flat panel display. The light source may be a cold cathode fluorescent lamp (CCFL), a light-emitting diode (LED) or another light source.

A constant backlight outputs even and constant light no matter how the image data or the ambient light has been changed. The constant backlight approach has a disadvantage, among others, that the display has light leakage caused by the backlight when pixels of the display are in dark level (“0”), which results in low dynamic contrast.

To address this disadvantage, a dynamic backlight (DBL) was devised in the prior art to dynamically or adaptively adjust (overall or respective portions of) the backlight brightness in accordance with image data distribution or the ambient light. For example, when the image was bright, the backlight outputted high brightness; and when the image was dark, the backlight was dimmed, thereby reducing light leakage. Accordingly, the dynamic backlight had a higher dynamic contrast than the constant backlight. Further, the dynamic backlight reduced power consumption as compared to a constant backlight.

Nonetheless, as the conventional dynamic backlight was illuminated to display the image in a digital way, the gray levels near the dark level (“0”) and the bright level (“255” for 8 bits of resolution) were not processed. Consequently, brightness loss occurred near the bright gray level (“255”) when the backlight reduced the brightness by reducing backlight duty, thus lowering the static contrast.

For reasons including the mentioned disadvantages of conventional dynamic backlights, a need has arisen to propose a novel scheme that reduces brightness loss in order to increase static contrast while maintaining high dynamic contrast and low light leakage.

### SUMMARY OF THE INVENTION

In view of the foregoing, it is an object of the present invention to provide a novel scheme that advantageously improves the “brightness loss” problem while maintaining low light leakage. Furthermore, the present invention increases both the static contrast and the dynamic contrast.

According to the embodiment, a gamma reference voltage generator adaptively generates an analog gamma reference voltage under control of a digital control signal. The digital control signal is specifically arranged to accordingly level-up (e.g., increase) an upper limit of a gamma curve, representing a relationship of generated analog gamma reference voltage with respect to a gray level of the gamma reference voltage generator, thereby improving the brightness loss in order to increase the static contrast while maintaining high dynamic contrast and low light leakage.

### BRIEF DESCRIPTION OF THE DRAWINGS

FIG. 1 illustrates a dynamic backlight control (DBLC) using an analog gamma reference voltage generating system according to one embodiment of the present invention;

FIG. 2A illustrates a flow diagram of reducing the brightness loss according to the embodiment of the present invention;

FIG. 2B shows the relationship of gamma reference voltage with respect to gray level;

FIG. 3A shows the relationship of illumination with respect to gray level of a conventional dynamic backlight control system without level-up/level-down adjusting the gamma reference voltage; and

FIG. 3B shows the relationship of illumination with respect to gray level of the dynamic backlight control system using level-up/level-down adjusting of the gamma reference voltage according to the present embodiment.

### DETAILED DESCRIPTION OF THE INVENTION

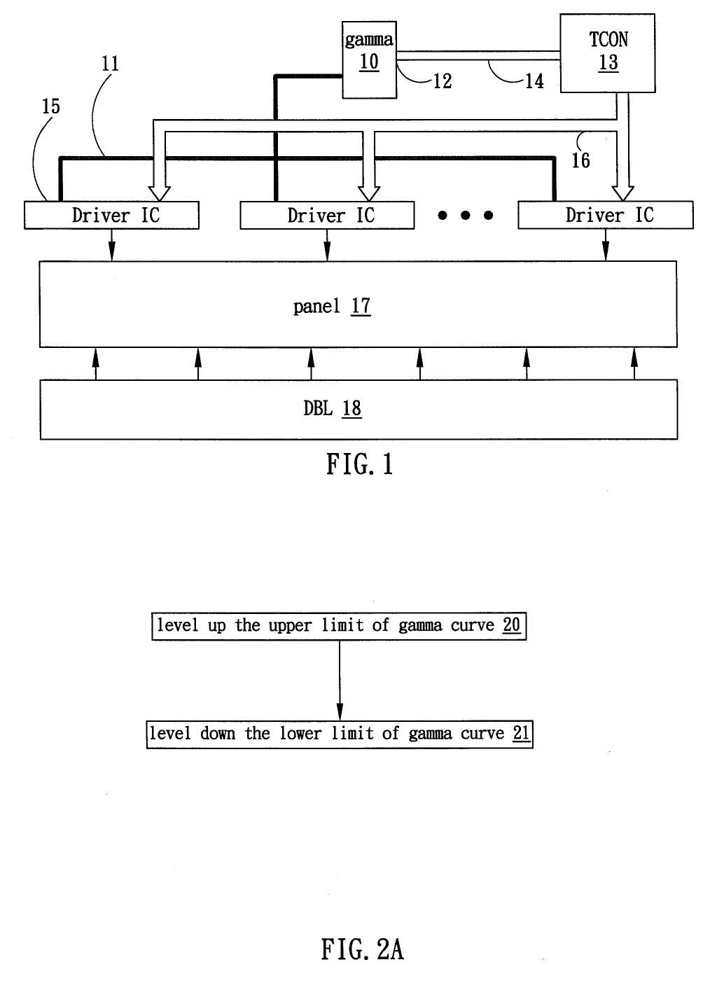

FIG. 1 illustrates a dynamic backlight control (DBLC) using an analog gamma reference voltage generating system according to one embodiment of the present invention. In the embodiment, an adaptive (or dynamic) gamma reference voltage generator 10 is capable of adaptively generating an analog gamma reference voltage 11 under control of digital control signal 12. The digital control signal 12 is provided by a timing controller (TCON) 13 through a digital interface 14. The digital interface 14, for example a bus, is electrically coupled, directly or indirectly, between the gamma reference voltage generator 10 and the timing controller 13. The analog gamma reference voltage 11, along with digital image data 16, is fed to a number of source driver integrated circuits (ICs) 15 for the purpose of correcting the non-linear perception of human eyes on the image constructed by the digital image data 16. The image is then displayed on a display panel 17 with a light source provided by a dynamic backlight (DBL) 18. The adaptive gamma reference voltage generator 10 is disclosed in “Contrast Enhancement in Liquid Crystal Displays by Adaptive Modification of Analog Gamma Reference Voltages” by Seung-Woo Lee, IEICE Trans. Electron., Vol. E90-C, No. 11, pp. 2083-2087, November 2007, the disclosure of which is hereby incorporated by reference.

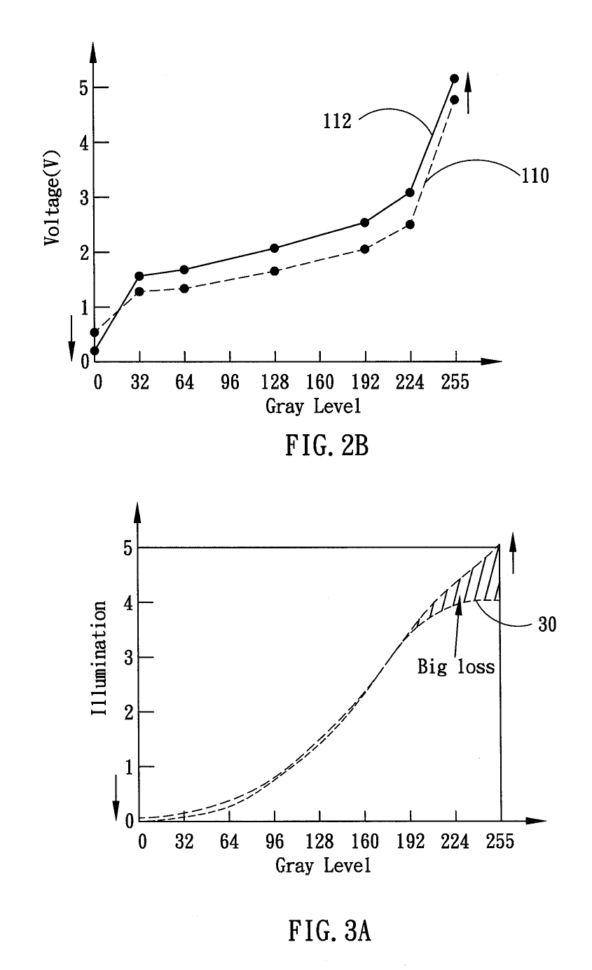

FIG. 2A illustrates a flow diagram of reducing the brightness loss according to the embodiment of the present invention, and FIG. 2B shows the relationship of gamma reference voltage with respect to gray level. In FIG. 2B, dotted line 110 represents the original (or conventional) gamma reference voltage curve (the “gamma curve”), and the solid line 112 represents a modified gamma curve after applying the present embodiment. Firstly, in step 20, the timing controller (TCON) 13 provides specific digital control signal 12 to the adaptive gamma reference voltage generator 10 via the digital interface 14. The digital control signal 12 is specifically arranged to accordingly level-up (e.g., increase) the upper limit of the gamma curve such that the value near the upper limit of the modified gamma curve 112 is increased approaching or being equal to the allowable maximum voltage (5 volts (V) in the exemplary figure). In the specification, the term “upper limit” may indicate a top range with, for example, 10% of the voltage scale (for example, 0-5 V). In practice, the upper limit of the gamma curve is leveled-up as close to the maximum voltage (5 V in the exemplary figure) as possible, on the condition that no other substantive negative effects arise.

In an optional step 21, the timing controller (TCON) 13 also provides specific digital control signal 12 that levels-down the lower limit of the gamma curve such that the value near the lower limit of the modified gamma curve 112 is decreased approaching or being equal to the allowable minimum voltage (0 volts (V) in the exemplary figure). In the specification, the term “lower limit” may indicate a bottom range with, for example, 10% of the voltage scale (for example, 0-5 V). In practice, the lower limit of the gamma curve is leveled-down as close to the minimum voltage (0 V in the exemplary figure) as possible, on the condition that no other substantive negative effects arise.

According to the embodiment, the leveling-up of the upper limit of the gamma curve substantively increases the illumination of the bright level (that is, the levels near the bright level “255”), and therefore the brightness loss phenomenon can be substantially improved even though the backlight 18 (FIG. 1) reduces brightness by reducing backlight duty for the purpose of reducing light leakage. Accordingly, the static contrast can be improved while maintaining high dynamic contrast and low light leakage.

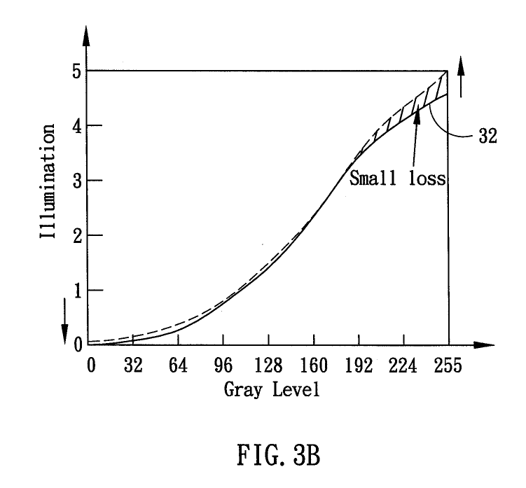

FIG. 3A shows the relationship of illumination with respect to gray level of a conventional dynamic backlight control system without level-up/level-down adjusting the gamma reference voltage, and FIG. 3B shows the relationship of illumination with respect to gray level of the dynamic backlight control system using level-up/level-down adjusting of the gamma reference voltage according to the present embodiment. Specifically, for the conventional backlight control system (FIG. 3A), a big brightness loss (i.e., the shaded area) occurs within the bright levels. In this figure, the dotted line 30 represents the curve after reducing backlight duty in a backlight for the purpose of reducing light leakage. To the contrary, for the dynamic backlight control system according to the present embodiment (FIG. 3B), the brightness loss is substantially improved as evidenced by the smaller shaded area. In this figure, the solid line 32 represents the curve after applying the level-up/level-down adjustment to the gamma reference voltage according to the present embodiment.

Although specific embodiments have been illustrated and described, it will be appreciated by those skilled in the art that various modifications may be made without departing from the scope of the present invention, which is intended to be limited solely by the appended claims.

What is claimed is:

1. A gamma reference voltage generating system adaptable for backlight control, comprising a gamma reference voltage generator for adaptively generating an analog gamma reference voltage under control of a digital control signal, the digital control signal being specifically arranged to accordingly level-up an upper limit of a gamma curve, which is representative of a relationship of generated analog gamma reference voltage with respect to a gray level of the gamma reference voltage generator, thereby improving brightness loss.

2. The system of claim 1, further comprising a timing controller that provides the digital control signal to the gamma reference voltage generator.

3. The system of claim 2, further comprising a digital interface connected between the gamma reference voltage generator and the timing controller for facilitating provision of the digital control signal to the gamma reference voltage generator.

4. The system of claim 1, further comprising at least a driver that drives a display panel and receives the generated analog gamma reference voltage.

5. The system of claim 1, wherein the upper limit of the gamma curve is leveled-up to approach an allowable maximum voltage of the gamma reference voltage generator.

6. The system of claim 1, the digital control signal being specifically arranged to accordingly level-down a lower limit of the gamma curve.

7. The system of claim 6, wherein the lower limit of the gamma curve is leveled-down to approach an allowable minimum voltage of the gamma reference voltage generator.

8. A flat panel display, comprising:
a display panel;
a dynamic backlight that dynamically provides light to the display panel;
a gamma reference voltage generator for adaptively generating an analog gamma reference voltage under control of a digital control signal;
a timing controller that provides the digital control signal to the gamma reference voltage generator through a digital interface; and
at least one driver that receives the generated analog gamma reference voltage;
wherein the digital control signal is specifically arranged to accordingly level-up an upper limit of a gamma curve, representing a relationship of generated analog gamma reference voltage with respect to a gray level of the gamma reference voltage generator, thereby improving brightness loss.

9. The display of claim 8, wherein the upper limit of the gamma curve is leveled-up to approach an allowable maximum voltage of the gamma reference voltage generator.

10. The display of claim 8, the digital control signal being specifically arranged to accordingly level-down a lower limit of the gamma curve.

11. The display of claim 10, wherein the lower limit of the gamma curve is leveled-down to approach an allowable minimum voltage of the gamma reference voltage generator.

12. A gamma reference voltage generating method adaptable for backlight control, comprising:
adaptively generating an analog gamma reference voltage under control of digital control signal;
arranging the digital control signal to accordingly level-up an upper limit of a gamma curve, representing a relationship of generated analog gamma reference voltage with respect to gray level, thereby improving brightness loss.

13. The method of claim 12, further comprising providing the digital control signal by a timing controller.

14. The method of claim 12, further comprising receiving the analog gamma reference voltage by at least one driver.

15. The method of claim 12, wherein the digital control signal is specifically arranged to accordingly level-down a lower limit of the gamma curve.
